(19) United States
(12) Patent Application Publication
(10) Pub. No.: US 2019/0304152 A1
(43) Pub. Date: Oct. 3, 2019

(54) METHOD AND DEVICE FOR PROCESSING IMAGE

(71) Applicant: Samsung Electronics Co., Ltd., Suwon-si (KR)

(72) Inventors: Albert SAÀ-GARRIGA, Staines (GB); Karthikeyan SARAVANAN, Staines (GB); Alessandro VANDINI, Staines (GB); Antoine LARRECHE, Staines (GB); Daniel ANSORREGUI, Staines (GB)

(21) Appl. No.: 16/364,866

(22) Filed: Mar. 26, 2019

(30) Foreign Application Priority Data
Mar. 29, 2018 (GB) 1805270.4
Feb. 12, 2019 (KR) 10-2019-0016357

(51) Int. Cl. G06T 11/60; G06K 9/00; G06K 9/62; G06T 5/00; G06T 5/10

(52) U.S. Cl. CPC G06T 11/60; G06K 9/00281; G06K 9/622; G06T 2207/30201; G06T 5/10; G06T 2207/20081; G06T 5/002

(57) ABSTRACT

An image processing method is provided. The image processing method includes detecting a face of an object present on an image, obtaining at least one feature from the detected face as at least one facial parameter and obtaining at least one context related to the image as at least one contextual parameter, determining a manipulation point for manipulating the detected face, based on the obtained at least one facial parameter and the obtained at least one contextual parameter, and manipulating the image based on the determined manipulation point.

### CROSS-REFERENCE TO RELATED APPLICATION(S)

This application is based on and claims priority under 35 U.S.C. § 119(a) of a Great Britain patent application number 1805270. 4, filed on Mar. 29, 2018, in the Intellectual Property Office (IPO), and of a Korean patent application number 10-2019-0016357, filed on Feb. 12, 2019, in the Korean Intellectual Property Office, the disclosure of each of which is incorporated by reference herein in its entirety.

### BACKGROUND

### 1. Field

The disclosure relates to methods and devices for processing an image. More particularly, the disclosure relates to methods of detecting and manipulating a face in an image and devices for performing the methods.

### 2. Description of Related Art

Owing to recent developments in image processing technology, face modeling algorithms of various forms have been developed to parameterize a subset of various descriptors that define a face on an image. However, these generic parametric models have a limited capacity to represent the specific detailed shape variations of an individual's facial expressions in accordance with circumstances. Therefore, there is a need for research into technology for manipulating a face on an image using context information.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below.

Additional aspects will be set forth in part in the description which follows and, in part, will be apparent from the description, or may be learned by practice of the presented embodiments.

In accordance with an aspect of the disclosure, an image processing method is provided. The image processing method includes detecting a face present in an image, obtaining at least one feature from the detected face as at least one facial parameter, obtaining at least one context related to the image as at least one contextual parameter, determining a manipulation point for manipulating the detected face, based on the obtained at least one facial parameter and the obtained at least one contextual parameter, and manipulating the image based on the determined manipulation point.

The determining of the manipulation point for manipulating the detected face may include selecting at least one parameter to be used to determine the manipulation point from among the at least one facial parameter, based on at least one of the obtained at least one contextual parameter.

The determining of the manipulation point for manipulating the detected face may include selecting, from among the at least one facial parameter, at least one parameter to be excluded from or corrected in a process of determining the manipulation point, based on at least one of the at least one contextual parameter.

The determining of the manipulation point may include when the obtained at least one contextual parameter is a plurality of contextual parameters, generating a plurality of clusters by combining the obtained at least one contextual parameter according to various combination methods and selecting one of the generated plurality of clusters and determining the manipulation point corresponding to the selected cluster.

One of the plurality of clusters may be selected using a machine learning algorithm with the obtained at least one contextual parameter as an input value.

The determining of the manipulation point may include selecting, from a plurality of face models, one face model to be combined with the detected face.

The manipulating of the image may include replacing at least a portion of the detected face with a corresponding portion of the selected face model.

The determining of the manipulation point may include selecting one of a plurality of image filters based on the obtained at least one facial parameter and the obtained at least one contextual parameter, and wherein the manipulating of the image includes applying the selected image filter to the image.

The at least one contextual parameter may include at least one of person identification information for identifying at least one person appearing on the image, a profile of the identified at least one person, a profile of a user manipulating the image, a relationship between the user manipulating the image and the identified at least one person, a location where the image was captured, a time when the image was captured, weather of an image capture time, information about a device used to capture the image, an image manipulation history of the user manipulating the image and the identified at least one person, or evaluation information of the image.

The selecting of the one face model to be combined with the detected face may include presenting a plurality of face models extracted based on the obtained at least one facial parameter and the obtained at least one contextual parameter to a user, and receiving a selection of one of the plurality of presented face models from the user.

In accordance with another aspect of the disclosure, an image processing device is provided. The image processing device includes at least one processor configured to detect a face present in an image, obtain at least one feature from the detected face as at least one facial parameter, obtain at least one context related to the image as at least one contextual parameter, determine a manipulation point for manipulating the detected face based on the obtained at least one facial parameter and the obtained at least one contextual parameter, and manipulate the image based on the determined manipulation point, and a display configured to display the manipulated image.

The at least one processor may be further configured to select, from among the at least one facial parameter, at least one parameter to be used to determine the manipulation point, based on at least one of the at least one contextual parameter.

The at least one processor may be further configured to select, from among the at least one facial parameter, at least one parameter to be excluded from or corrected in a process of determining the manipulation point, based on at least one of the at least one contextual parameter.

The at least one processor may be further configured to, when the obtained at least one contextual parameter is a plurality of contextual parameters, generate a plurality of clusters by combining the obtained at least one contextual parameter according to various combination methods, select one of the generated plurality of clusters, and determine the manipulation point corresponding to the selected cluster.

The at least one processor may be further configured to determine the manipulation unit by selecting, from a plurality of face models, one face model to be combined with the detected face.

The at least one processor may be further configured to manipulate the image by replacing at least a portion of the detected face with a corresponding portion of the selected face model.

The at least one processor may be further configured to determine the manipulation unit by selecting one of a plurality of image filters based on the obtained at least one facial parameter and the obtained at least one contextual parameter, and manipulate the image by applying the selected image filter to the image.

In accordance with another aspect of the disclosure, a non-transitory computer-readable recording medium having recorded thereon a computer program for executing the method is provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a configuration diagram of an image processing device according to an embodiment of the disclosure;

FIG. 2 is a flowchart of an image processing method according to an embodiment of the disclosure;

FIG. 3 is a diagram illustrating a method of manipulating an image, according to an embodiment of the disclosure;

FIG. 4 is a diagram of an example of a face model used to manipulate an image, according to an embodiment of the disclosure;

FIG. 5 is a diagram of an example of determining facial parameters to be applied based on contextual parameters, according to an embodiment of the disclosure;

FIG. 6 is a flowchart of an example of determining facial parameters to be applied based on contextual parameters, according to an embodiment of the disclosure;

FIG. 7 is a diagram of an example of applying contextual parameters and then applying facial parameters based on results thereof, according to an embodiment of the disclosure;

FIG. 8 is a flowchart of an example of applying contextual parameters and then applying facial parameters based on results thereof, according to an embodiment of the disclosure;

FIG. 9 is a structural diagram of a device for processing an image, according to an embodiment of the disclosure;

FIG. 10 is a flowchart of a method, performed by a clustering unit, of selecting a manipulation point using a machine learning algorithm, according to an embodiment of the disclosure;

FIG. 11 is another flowchart of an image processing method according to an embodiment of the disclosure;

FIG. 12 is another flowchart of an image processing method according to an embodiment of the disclosure;

FIG. 13 is a diagram illustrating an example of differently enhancing a face on an image according to a user by applying contextual parameters in a beauty application, according to an embodiment of the disclosure;

FIG. 14 is a diagram of an example of manipulating a face of an advertising model to be similar to that of a target consumer, according to an embodiment of the disclosure; and

FIG. 15 is a diagram of an example of manipulating a face on an image by applying contextual parameters to protect privacy, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms used herein are general terms that are currently widely used in consideration of functions in the disclosure but may vary according to intentions of those of ordinary skill in the art, precedents, appearances of new technologies, or the like. Also, the applicant may arbitrarily select terms in a specific case, and meanings of the terms corresponding to this case will be described in detail in the description of the disclosure. Therefore, the terms used herein may be defined based on meanings thereof and the overall contents of the disclosure not based on names of simple terms.

When a part “comprises” an element in the specification, this may mean that the part may not exclude and may further include other elements as long as there is no contrary description.

Reference will now be made in detail to the embodiment of the disclosure, examples of which are illustrated in the accompanying drawings, wherein like reference numerals refer to the like elements throughout. In order to clearly explain the disclosure in the drawings, portions not related to the description will be omitted.

Throughout the disclosure, the expression “at least one of a, b or c” indicates only a, only b, only c, both a and b, both a and c, both b and c, all of a, b, and c, or variations thereof.

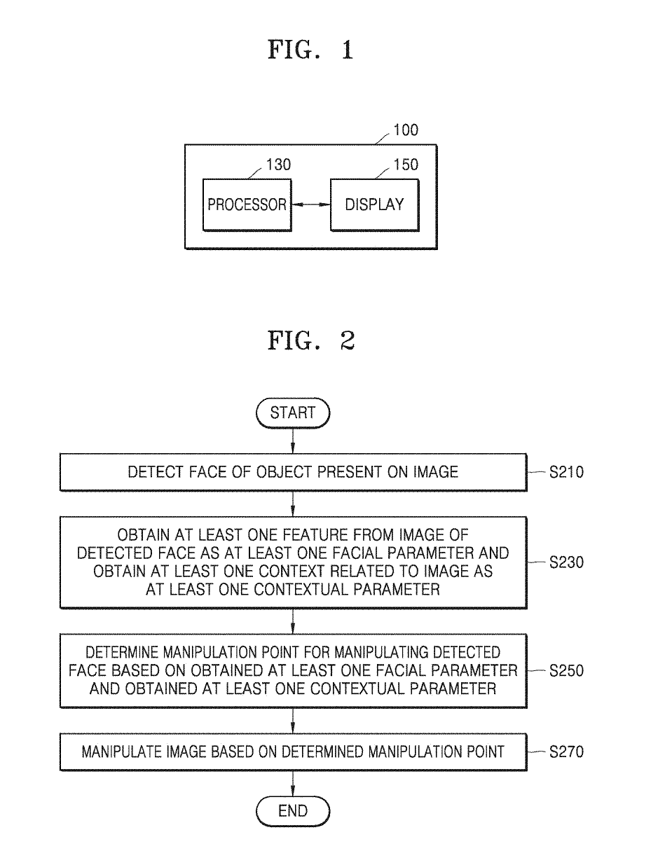

FIG. 1 is a configuration diagram of an image processing device 100 according to an embodiment of the disclosure.

Referring to FIG. 1, the image processing device 100 according to an embodiment of the disclosure may include a processor 130 and a display 150.

The processor 130 may detect a face of an object existing on an image. The processor 130 may include a plurality of processors.

One or more persons may be present on the image. The processor 130 may detect a face of each person and sequentially perform image manipulations of the disclosure on the detected face.

The processor 130 may also obtain at least one feature obtained from a detected face image as at least one facial parameter. Examples of a feature that may be obtained from the face image may include a type of a face, a size of the face, shapes of ears, eyes, mouth, and nose, a facial expression of a person, an emotion of a person, albedo of light with respect to a part of the face, intensity of illumination, a direction of illumination, etc.

A facial parameter may refer to information categorized by combining in various ways the above features which may be obtained from the face image that is an object of image manipulation. The facial parameter may be obtained in a variety of ways. For example, the facial parameter may be obtained by applying a facial parameterization algorithm to an image.

The processor 130 may also obtain at least one context related to the image as at least one contextual parameter. The context related to the image may include person identification information for identifying at least one person appearing on the image, a profile of the identified person, a user profile including nationality, age, race, sex, family relationship, friendship, etc. of a user of the image processing device 100, a relationship between the identified person and the user, a location where the image was captured, a time when the image was captured, weather of an image capture time, information about a device that captured the image, an image manipulation history of the user, an aesthetic preference of the user, evaluation information of the image, etc.

The context related to the image may be extracted from information about an image part other than the face image that is the object of manipulation, information about the user, information about the device, etc.

The contextual parameter may refer to information categorized by combining various contexts in various ways. The contextual parameter may include metadata related to an input image and information generated by analyzing the input image.

The processor 130 may also determine a manipulation point for manipulating the detected face from the image based on the obtained facial parameter and the obtained contextual parameter and manipulate the image based on the determined manipulation point. Determining of the manipulation point and manipulating he image based on the determined manipulation point will be described later in more detail.

The display 150 may output the image in which face manipulation is completed.

The display 150 may include a panel, a hologram device, or a projector.

The processor 130 and the display 150 are represented as separate configuration units, but the processor 130 and the display 150 may be combined and implemented in the same configuration unit.

Although the processor 130 and the display 150 are represented as configuration units positioned adjacent to an inside of the image processing device 100 in the embodiment of the disclosure, because there is no need for devices for performing the respective functions of the processor 130 and the display 150 to be physically adjacent, the processor 130 and the display 150 may be distributed according to an embodiment of the disclosure.

Also, because the image processing device 100 is not limited to a physical device, some functions of the image processing device 100 may be implemented in software rather than hardware.

According to an embodiment of the disclosure, the image processing device 100 may further include a memory, a capturer, a communication interface, etc.

Each of the elements described herein may include one or more components, and a name of each element may change according to a type of a device. The device may include at least one of the elements described herein, and may omit some elements or further include additional elements. Also, some of the elements of the device according to an embodiment of the disclosure may be combined into one entity such that the entity may perform functions of the elements before combined in the same manner.

FIG. 2 is a flowchart of an image processing method according to an embodiment of the disclosure.

Referring to FIG. 2, in operation S210, the image processing device 100 may detect a face of an object existing on an image. The image processing device 100 may use various types of face detection algorithms already known to detect the face of the object existing on the image.

When two or more persons are present on the image, the image processing device 100 may perform operations S230 to S270 on a face of each person.

In operation S230, the image processing device 100 may obtain at least one feature obtained from a detected face image as at least one facial parameter and obtain at least one context related to the image as at least one contextual parameter.

A facial parameter may refer to information obtained from the face image that is an object of image manipulation. A contextual parameter may refer to information obtained from a part of the image other than the face image that is the object of manipulation or information obtained from an outside of the image such as information about a user, information about a capturing device, etc.

An image parameter may include a type of a face, a size of the face, shapes of ears, eyes, mouth, and nose, a facial expression of a person, an emotion of a person, albedo of light with respect to a part of the face, intensity of illumination, a direction of illumination, etc.

The contextual parameter may include person identification information for identifying at least one person appearing on the image, a profile of the identified person, a user profile including nationality, age, race, sex, family relationship, friendship, etc. of a user of the image processing device 100, a relationship between the identified person and the user, a location where the image was captured, a time when the image was captured, weather of an image capture time, information about a device that captured the image, an image manipulation history of the user, an aesthetic preference of the user, evaluation information of the image, etc.

In operation S250, the image processing device 100 may determine a manipulation point for manipulating the detected face based on the obtained facial parameter and the obtained contextual parameter. The manipulation point may refer to a part of an original image that is to be changed.

The image processing device 100 may determine, based on context obtained from the image, at least one of face image features, such as a face shape of the person, a tone of the skin, or the intensity of illumination, etc. as the manipulation point.

For example, when context in which a time when the image is captured is dark night is obtained, the image processing device 100 may automatically apply a camera setting most used in capturing in a similar situation to a camera.

In another example, when context in which the image is captured in the dark night and the skin tone of the detected face is yellow is obtained, the image processing device 100 may determine the most suitable manipulation point for the detected face image based on statistical data of image manipulation used in an image obtained by capturing a person having a similar skin tone in a similar situation.

The image processing device 100 may determine the manipulation point by selecting one face model to be combined with the detected face from among a plurality of face models.

The plurality of face models may refer to various types of face models stored in the image processing device 100.

The image processing device 100 may present the plurality of face models extracted based on the obtained facial parameter and contextual parameter to the user and receive a selection of one of the presented face models from the user to determine the face model selected by the user as the manipulation point.

In operation S270, the image processing device 100 may manipulate the image based on the manipulation point.

The image processing device 100 may replace all or at least a portion of the detected face with a corresponding portion of the selected face model.

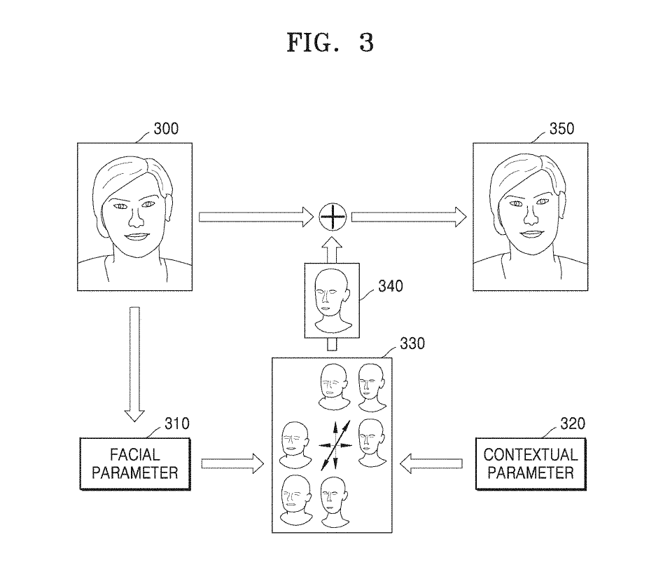

FIG. 3 is a diagram illustrating a method of manipulating an image according to an embodiment of the disclosure.

Referring to FIG. 3, the image processing device 100 may obtain from an image 300 at least one facial parameter 310 including various face features and at least one contextual parameter 320 including various contexts related to an image 300.

The image processing device 100 may apply the facial parameter 310 and the contextual parameter 320 to a plurality of stored face models 330 to select one face model 140.

The selected face model 340 may be a model most similar to a face feature on the image 300 selected from the various face models 330 according to the facial parameter 310 or may be a model selected from the various face models 330 according to the contextual parameter 320.

The image 300 may be combined with the selected face model 340 and changed to an output image 350. For example, the image processing device 100 may combine the selected face model 340 with a face on the original image 300 by blending the selected face model 340 with the face on the original image 300 or may combine the selected face model 340 with the face on the original image 300 by replacing at least a portion of the original image 300 with a corresponding portion of the face model 340.

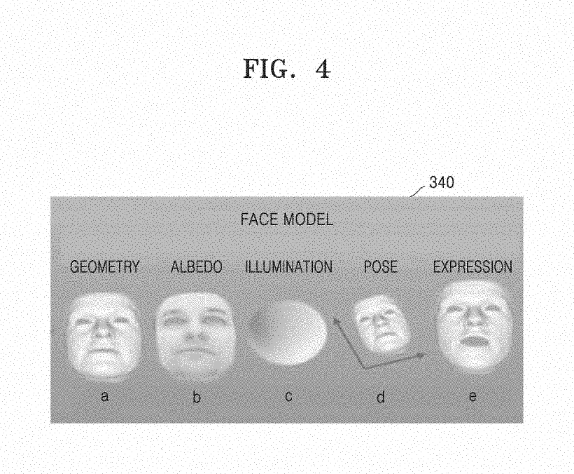

FIG. 4 is a diagram of an example of a face model used to manipulate an image according to an embodiment of the disclosure.

Referring to FIG. 4, the face model 340 may be a parameterized model. The face model 340 is the parameterized model may mean that the face model 340 is a model generated as a set of various parameters that determine an appearance of a face.

The face model 340 may include geometry information (a) defining a shape of the face, albedo information; (b) defining how incident light is reflected at different parts of the face, illumination information; (c) defining how illumination is applied during capturing, pose information about rotation; information (d) about zooming; facial expression information (e), etc.

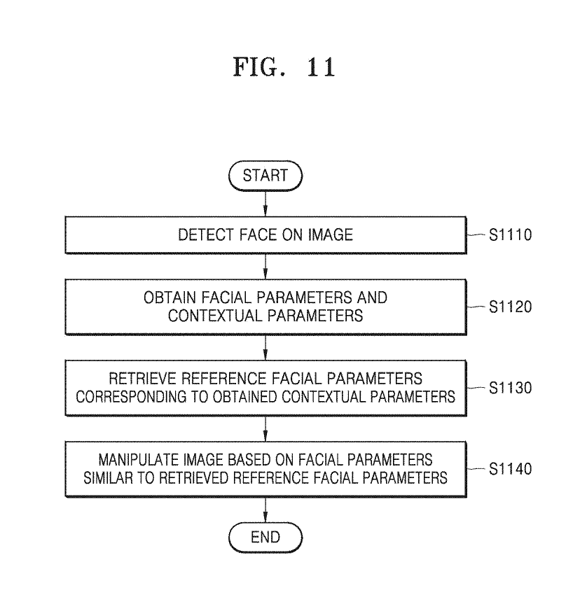

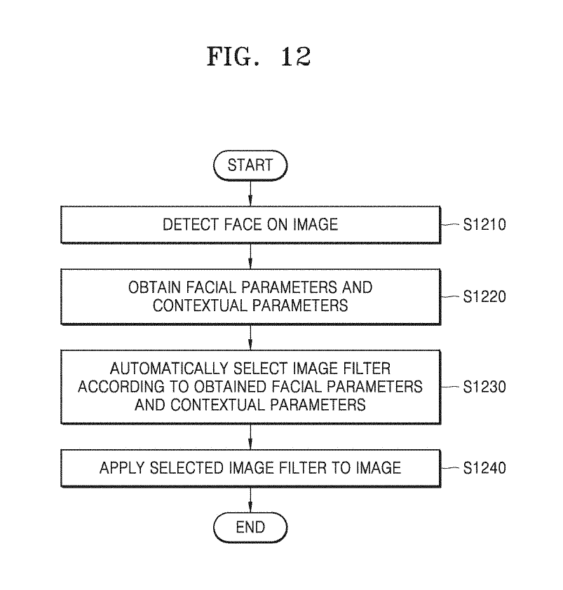

A method of manipulating the image according to an embodiment of the disclosure is not limited to using the parameterized face model, and various image manipulation methods such as the embodiment described below with respect to FIGS. 11 and 12 may be used.

By utilizing context information about the image, an image manipulation method capable of obtaining a more suitable result may be determined.

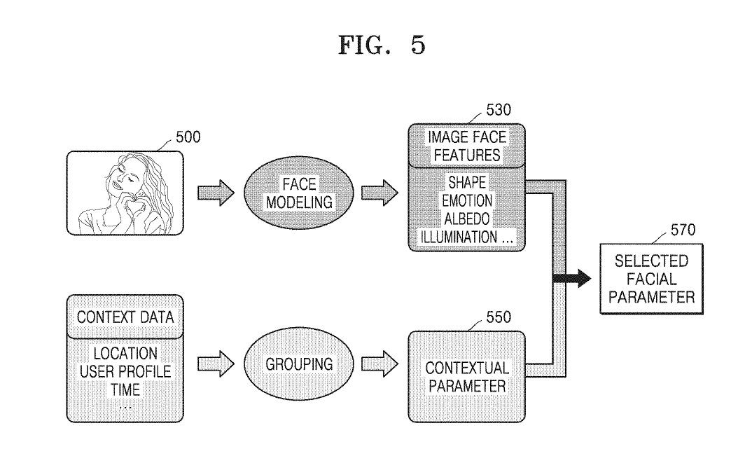

FIG. 5 is a diagram of an example of determining facial parameters to be applied based on contextual parameters, according to an embodiment of the disclosure.

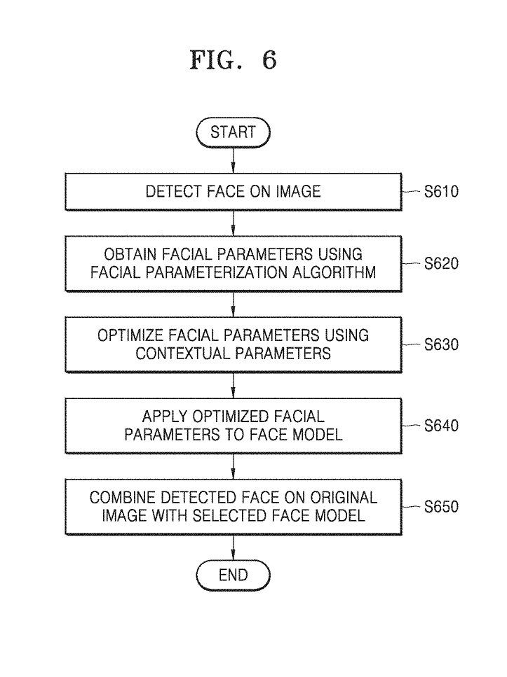

FIG. 6 is a flowchart of an example of determining facial parameters to be applied based on contextual parameters, according to an embodiment of the disclosure.

Referring to FIGS. 5 and 6, the image processing device 100 may determine a manipulation point for manipulating a face image based on the facial parameters and the contextual parameters. The facial parameters and the contextual parameters may be applied at the same time, and one of the facial parameters and the contextual parameters may be applied first, and the other one may be applied later.

Referring to FIG. 5, the image processing device 100 may select at least one parameter to be excluded or corrected in determining of the manipulation point among the facial parameters, based on at least one of the contextual parameters.

For example, the image processing device 100 may predict that, among facial parameters obtained from the face image due to strong illumination contrast, there may be a distortion in illumination information, based on a contextual parameter that a location where the image is captured is a bar. In this case, the image processing device 100 may exclude some of the facial parameters, that is, information about illumination, from determining of the manipulation point, based on the contextual parameter that the image is a capturing location.

In the embodiment illustrated in FIG. 5, the image processing device 100 may exclude or correct a specific facial parameter 570 from features 530 of the face image obtained from an image 500 based on a contextual parameter 550 and then apply the adjusted facial parameter 570 to selecting of a face model.

A detailed process in this regard is described below with respect to FIG. 6.

Referring to FIG. 6, in operation S610, the image processing device 100 may detect a face present on an image.

In operation S620, the image processing device 100 may apply a facial parameterization algorithm to the detected face to obtain facial parameters.

In operation S630, the image processing device 100 may optimize the facial parameters using contextual parameters obtained from an original image. Optimization of the facial parameters at a present stage may mean eliminating or correcting facial parameters that are likely to be distorted and adjusting the facial parameters to be applied to selecting of the face model.

In operation S640, the image processing device 100 may apply the optimized facial parameters to the face model to select one face model.

In operation S650, the image processing device 100 may manipulate the image by combining the selected face model with the detected face on the original image.

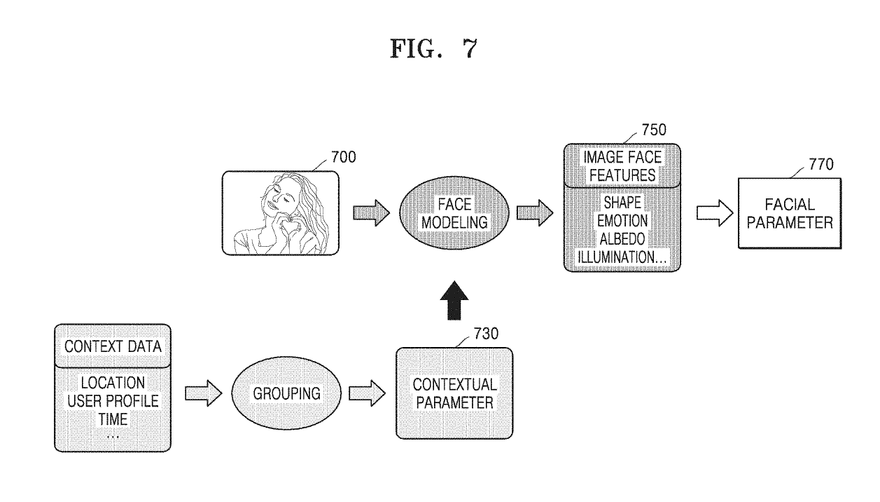

FIG. 7 is a diagram of an example of applying contextual parameters and then applying facial parameters based on results thereof, according to an embodiment of the disclosure.

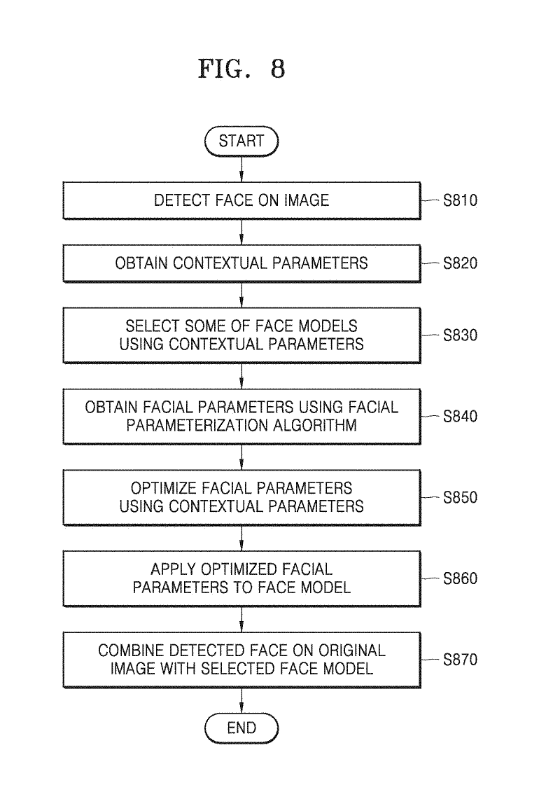

FIG. 8 is a flowchart of an example of applying contextual parameters and then applying facial parameters based on results thereof, according to an embodiment of the disclosure.

Referring to FIGS. 7 and 8, the image processing device 100 may determine a manipulation point for manipulating a face image based on the facial parameters and the contextual parameters. The facial parameters and the contextual parameters may be applied at the same time, and one of the facial parameters and the contextual parameters may be applied first, and the other one may be applied later.

Referring to FIGS. 7 and 8, the image processing device 100 may first apply the contextual parameters and then select at least one parameter to be used to determine the manipulation point among the facial parameters, based on at least one of the contextual parameters.

For example, the image processing device 100 may use statistical information about the tendency of users of a specific nationality to manipulate images to predict information about face features preferred by the users of the nationality.

In this case, the image processing device 100 may select facial parameters for the face features preferred by the users of the nationality to manipulate images, based on a contextual parameter that is a user's nationality, and apply only the selected parameters to selection of a face model.

In another example, the image processing device 100 may select facial parameters for face features that are primarily manipulated by users according to a time or a location at which images were captured, and apply only the selected parameters to the selection of the face model.

In the embodiment illustrated in FIG. 7, the image processing device 100 may first apply a contextual parameter 730 to an image 700 to select some of face models and select a facial parameter 770 to be applied to the selection of the face model from features 750 of the face image obtained from the image 700 according to the contextual parameter 730.

A detailed process in this regard is described below with respect to FIG. 8.

In operation S810, the image processing device 100 may detect a face present on an image.

In operation S820, the image processing device 100 may obtain the contextual parameters related to the image.

In operation S830, the image processing device 100 may apply the obtained contextual parameters to select some of a plurality of face models.

In operation S840, the image processing device 100 may apply a facial parameterization algorithm to the detected face to obtain the facial parameters.

In operation S850, the image processing device 100 may optimize the facial parameters using at least one of the contextual parameters. Optimization of the facial parameters at a present stage may mean selecting the facial parameters with respect to face features that are highly likely to be manipulated with respect to at least one contextual parameter.

In operation S860, the image processing device 100 may apply the optimized facial parameters to the face models to select one face model.

In operation S870, the image processing device 100 may manipulate the image by combining the selected face model with the detected face on an original image.

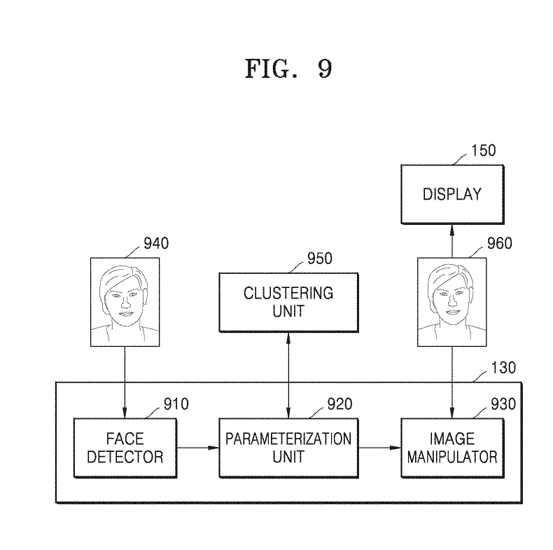

FIG. 9 is a structural diagram of a device for processing an image according to an embodiment of the disclosure.

Referring to FIG. 9, the image processing device 100 according to an embodiment of the disclosure may include a processor 130, a display 150 and a clustering unit 950. The processor 130 may include a face detector 910, a parameterization unit 920, and an image manipulator 930 therein.

The processor 130 and the display 150 according to the embodiment illustrated in FIG. 9 may perform all the functions described in FIG. 1, except for a function performed by the clustering unit 950.

The face detector 910 may detect a face of a person from an input image 940. The face detector 910 may use one of various face detection algorithms to detect a face of one or more persons present in the input image 940.

The parameterization unit 920 may obtain contextual parameters based on context information related to the image and obtain facial parameters based on features of the image of the detected face. The parameterization unit 920 may transmit the obtained contextual parameters and facial parameters to the clustering unit 950 and receive a manipulation point from the clustering unit 950.

The clustering unit 950 may apply a machine learning algorithm to the contextual parameters and facial parameters received from the parameterization unit 920 to identify a manipulation point related to a specific cluster and transmit the identified manipulation point to the parameterization unit 920.

A cluster may refer to a set of contextual parameters generated by combining obtained contextual parameters according to various combination methods when the obtained contextual parameters are plural.

The cluster may refer to global data commonality for each contextual parameter.

For example, a set of contextual parameters for a specific location may indicate a commonality for images captured at the location.

The clustering unit 950 may select one of a plurality of clusters based on the contextual parameters and the facial parameters and determine a manipulation point corresponding to the selected cluster.

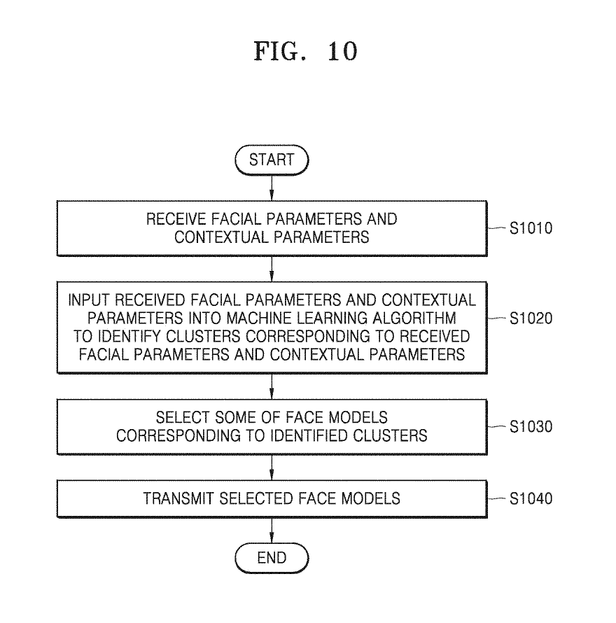

The clustering unit 950 is described in more detail below with respect to FIG. 10.

In an embodiment of the disclosure, the clustering unit 950 is not present within the image processing device 100, but may be present in an external server. In this case, the image processing unit may include a communicator (including a transmitter and receiver) to transmit data to, and receive data from, the external server.

The image manipulator 930 may manipulate the input image 940 based on the determined manipulation point to generate an output image 960.

Although the face detector 910, the parameterization unit 920, the image manipulator 930 and the clustering unit 950 are represented as configuration units positioned adjacent to an inside of the image processing device 100 in the embodiment of the disclosure, because there is no need for devices for performing the respective functions of the face detector 910, the parameterization unit 920, the image manipulator 930 and the clustering unit 950 to be physically adjacent, the face detector 910, the parameterization unit 920, the image manipulator 930 and the clustering unit 950 may be distributed according to an embodiment of the disclosure.

Also, because the image processing device 100 is not limited to a physical device, some of functions of the image processing device 100 may be implemented in software rather than hardware.

FIG. 10 is a flowchart of a method performed by a clustering unit of selecting a manipulation point using a machine learning algorithm according to an embodiment of the disclosure.

Referring to FIG. 10, in operation S1010, the clustering unit 950 may receive an input of facial parameters and contextual parameters.

In operation S1020, the clustering unit 950 may input the received facial parameters and contextual parameters into the machine learning algorithm to identify clusters corresponding to the received facial parameters and contextual parameters. The machine learning algorithm may be trained to identify a specific cluster to which a current image belongs based on at least one of facial parameters or contextual parameters. The clustering unit 950 may use a neural network, clustering algorithm, or other suitable methods to identify the clusters corresponding to the received facial parameters and contextual parameters.

In operation S1030, the clustering unit 950 may select face models corresponding to the identified clusters. In an embodiment of the disclosure, a current operation is not performed by the clustering unit 950 and may be performed on a recipient side that received the transmitted cluster. In this case, the clustering unit 950 may output the identified cluster as a resultant output and select the face model corresponding to the cluster identified on the recipient side that received the identified cluster.

Also, in the embodiment of the disclosure illustrated in FIG. 10, the face model is used to determine the manipulation point, but other methods such as an image filter may also be used.

In operation S1040, the clustering unit 950 may transmit the selected face models as an output.

In an embodiment of the disclosure, the clustering unit 950 may transmit the selected face model and then update the face model according to the received facial parameters and contextual parameters. In an embodiment of the disclosure, the clustering unit 950 may store the updated face model and use the face model for processing of a next image.

Through this process, the clustering unit 950 may develop itself by continuously updating the stored face model and improving the cluster.

The order of the update job may be changed. For example, the update job may be performed in operations previous to the current operation or may be performed between other operations.

FIG. 11 is another flowchart of an image processing method according to an embodiment of the disclosure.

Referring to FIG. 110 The image processing device 100 may, in some embodiments, not use a face model to determine a manipulation point.

The image processing device 100 may detect a face present on an image in operation S1110.

The image processing device 100 may obtain facial parameters and contextual parameters in operation S1120. A method of obtaining the facial parameters and the contextual parameters is described above with respect to FIGS. 1 and 2.

The image processing device 100 may retrieve reference facial parameters corresponding to the obtained contextual parameters in operation S1130.

The image processing device 100 may determine a manipulation point by retrieving the reference facial parameters corresponding to the obtained contextual parameters.

For example, the image processing device 100 may determine a color filter capable of representing a facial albedo similar to a reference albedo as the manipulation point.

In another example, the image processing device 100 may change a face type on the image by determining the face type capable of representing a geometry model similar to a reference geometry model as the manipulation point.

The image processing device 100 may manipulate a face image based on facial parameters similar to the retrieved reference facial parameters in operation S1140.

FIG. 12 is another flowchart of an image processing method according to an embodiment of the disclosure.

Referring to FIG. 12, the image processing device 100 may use an image filter instead of a face model to determine a manipulation point.

The image processing device 100 may detect a face present on an image in operation S1210.

The image processing device 100 may obtain facial parameters and contextual parameters in operation S1220. A method of obtaining the facial parameters and the contextual parameters is described above with respect to FIGS. 1 and 2.

The image processing device 100 may automatically select an image filter according to the obtained facial parameters and contextual parameters in operation S1230.

The image processing device 100 may select one image filter according to the obtained facial parameters and contextual parameters from among a plurality of stored image filters.

The image processing device 100 may apply the selected image filter to the image in operation S1240.

The image processing method according to the embodiment of the disclosure of FIG. 12 may be used to automatically set a camera effect that matches context information at the time of capturing when a user takes a picture. For example, a specific user may use his or her own image filter optimized for him/her.

In an embodiment of the disclosure, the image processing device 100 may select a de-noising camera filter according to the facial parameters and the contextual parameters. The image processing device 100 may use the same de-noising filter that was previously used for a face similar to a previously processed image.

Also, the image processing device 100 may automatically apply the same camera settings as camera settings that were previously used at the same capturing location when capturing the image.

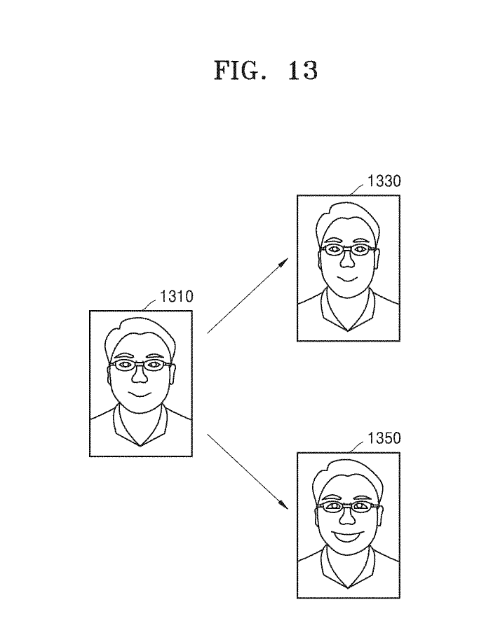

FIG. 13 is a diagram illustrating an example of differently enhancing a face on an image according to a user by applying contextual parameters in a beauty application according to an embodiment of the disclosure.

Referring to FIG. 13, an image processing method may be applied to a portrait beauty application and used to automatically enhance a face of a person.

Because the concept of beauty is subjective, depending on a taste of each person or a cultural background, beauty may mean different things to different people.

For example, people of a culture A may think that a person with a thin face and a narrow face is a beautiful person, whereas people of a culture B may think that a person with a big mouth as a beautiful person.

With respect to an original image 1310, when a person of the culture A is a user, the image processing device 100 may determine a face type as a manipulation point and manipulate the face type to be thin (1330), and when a person of the culture B is the user, may determine a size of mouth as the manipulation unit and manipulate the size of mouth to be large (1350).

The image processing device 100 may perform an appropriate manipulation in accordance with a beauty concept of each user by using context information such as information about a nationality and location of the user, thereby enhancing a face image.

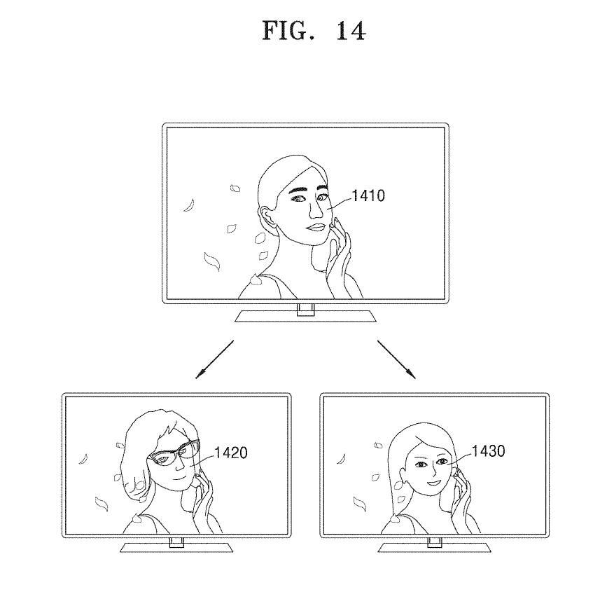

FIG. 14 is a diagram of an example of manipulating a face of an advertising model to be similar to that of a target consumer according to an embodiment of the disclosure.

Referring to FIG. 14, the image processing device 100 may manipulate a face 1410 of an actor used in a commercial advertisement as an appearance similar to that of a viewer or the target consumer. This is to increase the effect of advertisement by using the tendency of humans who have good feelings toward people having appearances similar to themselves.

The image processing device 100 may enhance concentration of the target consumer for the advertisement by manipulating the face 1410 of the actor to be similar to an average face of the target consumer (1420 and 1430).

In a similar example, the image processing device 100 may enhance concentration of a user by manipulating a game character on a video game as a face similar to the user by utilizing context information such as an appearance of the user.

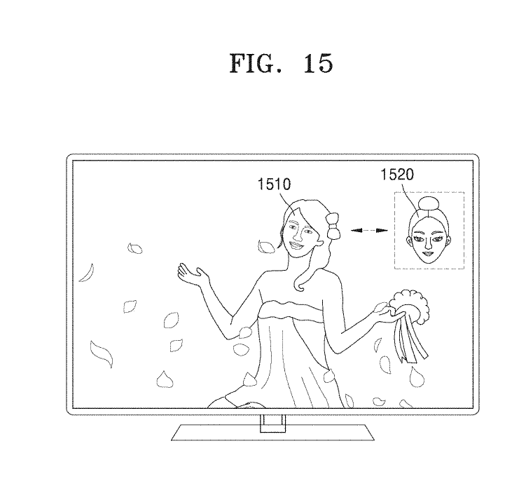

FIG. 15 is a diagram of an example of manipulating a face on an image by applying contextual parameters to protect privacy according to an embodiment of the disclosure.

Referring to FIG. 15, an image processing method according to an embodiment of the disclosure may be utilized to apply the contextual parameters and manipulate the face, instead of blurring a face on a photograph to protect privacy.

The image processing device 100 may protect privacy of a person on an original image by changing a face 1510 on the image to any other face 1520 or a wanted face 1520 instead of blurring the face 1510 on the image.

Blurring of the face 1510 on the image may make an image of the entire photo unnatural, which may lower the value of the photo. In this case, when the face 1510 on the image is not blurred but is manipulated according to the context information, a phenomenon that the photo becomes unnatural or all eyes are concentrated on a blurred part may be prevented.

An embodiment of the disclosure may be implemented by storing computer-readable codes in a non-transitory computer-readable storage medium. The non-transitory computer-readable storage medium is any data storage device that stores data which may be thereafter read by a computer system.

The computer-readable codes are configured to perform operations of implementing a capturing device control method according to the embodiment of the disclosure when the computer-readable codes are read, from the non-transitory computer-readable storage medium, and executed by a processor. The computer-readable codes may be implemented in a variety of programming languages. Functional programs, codes, and code segments for implementing the embodiment of the disclosure may be easily programmed by those skilled in the art to which the embodiment of the disclosure belongs.

Examples of the non-transitory computer-readable storage medium include read only memory (ROM), random access memory (RAM), compact disc (CD)-ROMs, magnetic tape, floppy disk, optical data storage devices. The non-transitory computer-readable storage medium may also be distributed over a network coupled computer system so that the computer-readable codes are stored and executed in distributed fashion.

It will be understood that the foregoing description of the disclosure is for the purpose of illustration only and that those skilled in the art will readily understand that various changes in form and details may be made therein without departing from the spirit and scope of the disclosure. It will be therefore understood that the above-described embodiments of the disclosure are illustrative in all aspects and not restrictive. For example, each element described as a single form may be distributed and implemented, and elements described as distributed may also be implemented in a combination form.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An image processing method comprising:
detecting a face present in an image;
obtaining at least one feature from the detected face as at least one facial parameter;
obtaining at least one context related to the image as at least one contextual parameter;
determining a manipulation point for manipulating the detected face, based on the obtained at least one facial parameter and the obtained at least one contextual parameter; and
manipulating the image based on the determined manipulation point.

2. The image processing method of claim 1, wherein the determining of the manipulation point for manipulating the detected face comprises:
selecting at least one parameter to be used to determine the manipulation point from among the obtained at least one facial parameter, based on at least one of the obtained at least one contextual parameter.

3. The image processing method of claim 1, wherein the determining of the manipulation point for manipulating the detected face comprises:
selecting, from among the obtained at least one facial parameter, at least one parameter to be excluded from or corrected in a process of determining the manipulation point, based on at least one of the obtained at least one contextual parameter.

4. The image processing method of claim 1, wherein the determining of the manipulation point comprises:
when the obtained at least one contextual parameter is a plurality of contextual parameters:
generating a plurality of clusters by combining the obtained at least one contextual parameter according to various combination methods, and
selecting one of the generated plurality of clusters; and
determining the manipulation point corresponding to the selected cluster.

5. The image processing method of claim 4, wherein the selected cluster is selected using a machine learning algorithm with the obtained at least one contextual parameter as an input value.

6. The image processing method of claim 1, wherein the determining of the manipulation point comprises:
selecting, from a plurality of face models, a face model to be combined with the detected face.

7. The image processing method of claim 6, wherein the manipulating of the image comprises:
replacing at least a portion of the detected face with a corresponding portion of the selected face model.

8. The image processing method of claim 1,
wherein the determining of the manipulation point comprises selecting one of a plurality of image filters based on the obtained at least one facial parameter and the obtained at least one contextual parameter, and
wherein the manipulating of the image comprises applying the selected image filter to the image.

9. The image processing method of claim 1, wherein the at least one contextual parameter comprises at least one of person identification information for identifying at least one person appearing on the image, a profile of the identified at least one person, a profile of a user manipulating the image, a relationship between the user manipulating the image and the identified at least one person, a location where the image was captured, a time when the image was captured, weather of an image capture time, information about a device used to capture the image, an image manipulation history of the user manipulating the image and the identified at least one person, or evaluation information of the image.

10. The image processing method of claim 6, wherein the selecting of the one face model to be combined with the detected face comprises:
presenting a plurality of face models extracted based on the obtained at least one facial parameter and the obtained at least one contextual parameter to a user; and
receiving a selection of one of the plurality of presented face models from the user.

11. An image processing device comprising:
at least one processor configured to:
detect a face present in an image,
obtain at least one feature from the detected face as at least one facial parameter,
obtain at least one context related to the image as at least one contextual parameter,
determine a manipulation point for manipulating the detected face based on the obtained at least one facial parameter and the obtained at least one contextual parameter, and
manipulate the image based on the determined manipulation point; and
a display configured to display the manipulated image.

12. The image processing device of claim 11, wherein the at least one processor is further configured to select, from among the obtained at least one facial parameter, at least one parameter to be used to determine the manipulation point, based on at least one of the obtained at least one contextual parameter.

13. The image processing device of claim 11, wherein the at least one processor is further configured to select, from among the obtained at least one facial parameter, at least one parameter to be excluded from or corrected in a process of determining the manipulation point, based on at least one of the at least one contextual parameter.

14. The image processing device of claim 11, wherein the at least one processor is further configured to:
when the obtained at least one contextual parameter is a plurality of contextual parameters:
generate a plurality of clusters by combining the obtained at least one contextual parameter according to various combination methods, and
select one of the generated plurality of clusters, and
determine the manipulation point corresponding to the selected cluster.

15. The image processing device of claim 14, wherein the selected cluster is selected using a machine learning algorithm with the obtained at least one contextual parameter as an input value.

16. The image processing device of claim 11, wherein the at least one processor is further configured to determine the manipulation unit by selecting, from a plurality of face models, one face model to be combined with the detected face.

17. The image processing device of claim 16, wherein the at least one processor is further configured to manipulate the image by replacing at least a portion of the detected face with a corresponding portion of the selected face model.

18. The image processing device of claim 11, wherein the at least one processor is further configured to determine the manipulation unit by selecting one of a plurality of image filters based on the obtained at least one facial parameter and the obtained at least one contextual parameter, and manipulate the image by applying the selected image filter to the image.

19. The image processing device of claim 11, wherein the at least one contextual parameter comprises at least one of person identification information for identifying at least one person appearing on the image, a profile of the identified at least one person, a profile of a user manipulating the image, a relationship between the user manipulating the image and the identified at least one person, a location where the image was captured, a time when the image was captured, weather of an image capture time, information about a device used to capture the image, an image manipulation history of the user manipulating the image and the identified at least one person, or evaluation information of the image.

20. A non-transitory computer-readable recording medium having recorded thereon a computer program for executing a method comprising:
detecting a face present in an image;
obtaining at least one feature from the detected face as at least one facial parameter;
obtaining at least one context related to the image as at least one contextual parameter;
determining a manipulation point for manipulating the detected face, based on the obtained at least one facial parameter and the obtained at least one contextual parameter; and
manipulating the image based on the determined manipulation point.

21. The image processing device of claim 11, further comprising:
a communicator configured to communicate with an external server,
wherein the processor is further configured to:
transmit the at least one contextual parameter to the external server, and
receive, from the external server, a cluster determined based on the at least one contextual parameter, and
wherein the at least one processor determines the manipulation point based on the received cluster.

22. The image processing device of claim 11, wherein the processor is further configured to manipulate the image by blurring the detected face.
